(19) United States
(12) Patent Application Publication
(10) Pub. No.: US 2023/0407124 A1
(43) Pub. Date: Dec. 21, 2023

(54) INK COMPOSITION, LAYER, ELECTROPHORESIS APPARATUS, AND DISPLAY DEVICE USING THE SAME

(71) Applicant: Samsung Display Co., LTD., Yongin-si (KR)

(72) Inventors: Janghyuk KIM, Yongin-si (KR); Kyuyoung KIM, Yongin-si (KR); MISUN KIM, Yongin-si (KR); CHULJIN PARK, Yongin-si (KR); Heeje WOO, Yongin-si (KR); Jinsuop YOUN, Yongin-si (KR); HYUNMOO CHOI, Yongin-si (KR); Minjun KIM, Yongin-si (KR); EUN SUN YU, Yongin-si (KR)

(21) Appl. No.: 18/336,350

(22) Filed: Jun. 16, 2023

(30) Foreign Application Priority Data
Jun. 17, 2022 (KR) 10-2022-0074408

(51) Int. Cl. C09D 11/52; C09D 11/037; C09D 11/033; G02F 1/167

(52) U.S. Cl. CPC C09D 11/52; C09D 11/037; C09D 11/033; G02F 1/167; G02F 2202/36; G02F 2001/1678

(57) ABSTRACT

Disclosed are an ink composition, a layer manufactured using the ink composition, an electrophoresis apparatus including the layer, and a display device, the ink composition including (A) a semiconductor nanorod, and (B) a solvent including a compound having a set or specific structure, wherein the solvent has an electrical conductivity of less than 2.0 μS/m at 25° C.

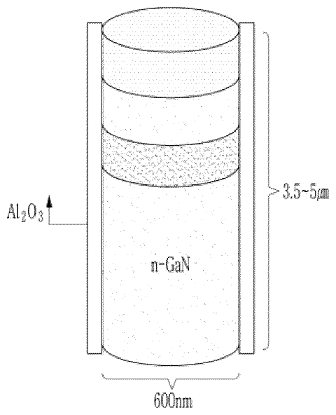

### CROSS-REFERENCE TO RELATED APPLICATION

This application claims priority to and the benefit of Korean Patent Application No. 10-2022-0074408 filed in the Korean Intellectual Property Office on Jun. 17, 2022, the entire contents of which are hereby incorporated by reference.

### BACKGROUND

### 1. Field

Embodiments of this disclosure relate to an ink composition, and a layer, an electrophoresis apparatus, and a display device using the same.

### 2. Description of the Related Art

Light emitting diodes (LEDs) have been actively developed since 1992 when Nakamura and others from the Japanese company Nichia Corp. succeeded in fusing a high-quality single crystal GaN nitride semiconductor by applying a low temperature GaN compound buffer layer. An LED is a semiconductor device that converts electric signals into light having wavelengths in a desired region by using characteristics of a compound semiconductor, which has a structure in which an n-type semiconductor crystal in which a plurality of carriers are electrons and a p-type semiconductor crystal in which a plurality of carriers are holes are combined together with each other.

This LED semiconductor has high light conversion efficiency and thus consumes very little energy and has a semi-permanent life-span, and also, is environmentally-friendly and is thus referred to as a revolution of light as a green material. Recently, high luminance red, orange, green, blue, and white LEDs have been developed with the development of compound semiconductor technology and are being applied in many fields such as traffic lights, mobile phones, car headlights, outdoor billboards, liquid crystal display (LCD) back light units (BLUs), and indoor/outdoor lighting, which keeps being actively researched at home and abroad. For example, a GaN-based compound semiconductor having a wide bandgap is a material used to manufacture an LED semiconductor emitting light in green, blue, and ultraviolet (UV) regions, and because a blue LED device is used to manufacture a white LED device, substantial amounts of research is being conducted on blue LED devices.

Among these series of studies, studies using ultra-small LED devices having a nano or micro unit size are being actively conducted, and in addition, studies for utilizing these ultra-small LED devices in lighting and displays are being continuously made. In these studies, electrodes capable of applying power to the ultra-small LED devices, disposition of the electrodes for reducing a space occupied by the electrodes, a method of mounting the ultra-small LED devices on the disposed electrodes, and the like are continuously attracting attention.

Among these, the method of mounting the ultra-small LED devices on the disposed electrodes still has difficulties of disposing and mounting the ultra-small LED devices on the electrodes as intended due to size limitations of the ultra-small LED devices. The reason is that the ultra-small LED devices are nano-scale or micro-scale and thus may not be disposed and mounted by hand on a target electrode region one by one.

Recently, as the demand for the nano-scale ultra-small LED devices is increasing, an attempt to manufacture a nano-scale GaN-based or InGaN-based compound semiconductor into a rod has been made, but there is a problem that dispersion stability of a nanorod itself in a solvent (or a polymerizable compound) is greatly deteriorated or reduced. Until now, there has been no introduction of a technology for improving the dispersion stability of the semiconductor nanorod in a solvent (or a polymerizable compound). Therefore, research on an ink composition including semiconductor nanorods capable of improving the dispersion stability of semiconductor nanorods in a solvent (or polymerizable compound) and realizing a high dielectrophoresis rate is ongoing.

### SUMMARY

An embodiment of the present disclosure provides an ink composition having excellent electrophoretic characteristics of semiconductor nanorods.

Another embodiment provides a layer manufactured using the ink composition.

Another embodiment provides an electrophoresis apparatus including the layer.

Another embodiment provides a display device apparatus including the layer.

An embodiment provides an ink composition including (A) a semiconductor nanorod and (B) a solvent including a compound represented by Chemical Formula 1, wherein the solvent has an electrical conductivity of less than 2.0 μS/m at 25° C.

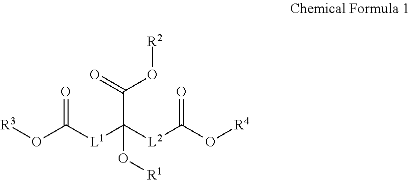

In Chemical Formula 1,
R¹ is a hydrogen atom or *—C(═O)R′ (wherein R′ is a hydrogen atom or a substituted or unsubstituted C1 to C10 alkyl group),
R² to R⁴ are each independently a substituted or unsubstituted C2 to C20 alkyl group, and
L¹ and L² are each independently a substituted or unsubstituted C1 to C20 alkylene group.

The solvent may have a dielectric constant (εᵣ) of about 5 to about 10 at 25° C.

The compound represented by Chemical Formula 1 may include a compound represented by Chemical Formula 1-1 or Chemical Formula 1-2.

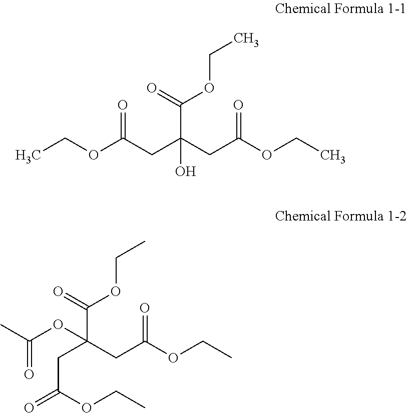

The solvent may further include at least one compound having a different structure from that of the compound represented by Chemical Formula 1.

The solvent further including at least one compound having a different structure from the compound represented by Chemical Formula 1 may have an electrical conductivity of less than or equal to about 0.3 μS/m at 25° C.

The solvent may further include a compound represented by Chemical Formula 2.

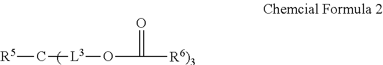

In Chemical Formula 2,
R⁵ and R⁶ are each independently a hydrogen atom or a substituted or unsubstituted C1 to C10 alkyl group, and
L³ is a substituted or unsubstituted C1 to C20 alkylene group.

The solvent may further include a compound represented by Chemical Formula 3, a compound represented by Chemical Formula 4, or a combination thereof.

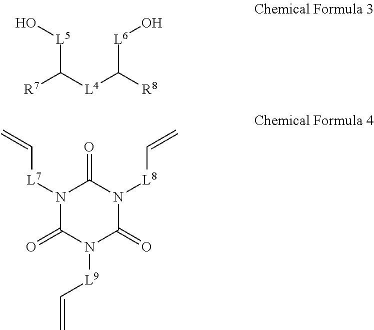

In Chemical Formula 3 and Chemical Formula 4,
R⁷ and R⁸ are each independently a hydrogen atom or a substituted or unsubstituted C1 to C10 alkyl group, and
L⁴ to L⁹ are each independently a substituted or unsubstituted C1 to C20 alkylene group.

The solvent may further include a compound represented by Chemical Formula 5, a compound represented by Chemical Formula 6, a compound represented by Chemical Formula 7, or a combination thereof.

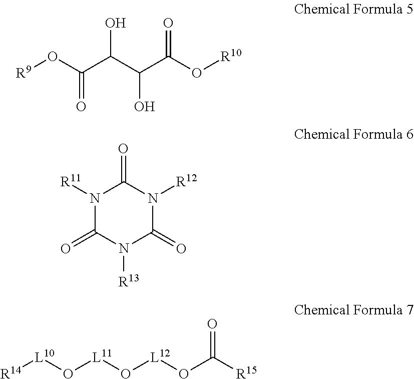

In Chemical Formula 5 to Chemical Formula 7,
R⁹ to R¹⁵ are each independently a hydrogen atom or a substituted or unsubstituted C1 to C10 alkyl group, and
L¹⁰ to L¹² are each independently a substituted or unsubstituted C1 to C20 alkylene group.

The solvent may further include a compound represented by Chemical Formula 8.

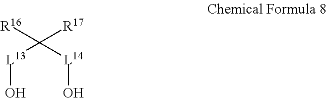

In Chemical Formula 8,
R¹⁶ and R¹⁷ are each independently a hydrogen atom or a substituted or unsubstituted C1 to C10 alkyl group, and
L¹³ and L¹⁴ are each independently a substituted or unsubstituted C1 to C20 alkylene group.

In Chemical Formula 8, R¹⁶ and R¹⁷ may each independently be a substituted or unsubstituted C1 to C10 alkyl group, and R¹⁶ and R¹⁷ may be different from each other.

The semiconductor nanorod may have a diameter of about 300 nm to about 900 nm.

The semiconductor nanorod may have a length of about 3.5 μm to about 5 μm.

The semiconductor nanorod may include a GaN-based compound, an InGaN-based compound, or a combination thereof.

The semiconductor nanorod may have a surface coated with a metal oxide.

The metal oxide may include alumina, silica, or a combination thereof.

The semiconductor nanorod may be included in an amount of about 0.01 wt % to about 10 wt % based on the total amount of the ink composition.

The ink composition may further include: malonic acid; 3-amino-1,2-propanediol; a silane-based coupling agent; a leveling agent; a fluorine-based surfactant; or a combination thereof.

The ink composition may be an ink composition for an electrophoresis apparatus.

Another embodiment provides a layer manufactured using the ink composition.

Another embodiment provides an electrophoresis apparatus including the layer.

Another embodiment provides a display device including the layer.

Other embodiments are included in the following detailed description.

The ink composition including semiconductor nanorods according to an embodiment may have excellent electrophoretic characteristics.

### BRIEF DESCRIPTION OF THE DRAWING

The accompanying drawing, together with the specification, illustrates embodiments of the subject matter of the present disclosure, and, together with the description, serves to explain principles of embodiments of the subject matter of the present disclosure.

The accompanying drawing is an example of a cross-sectional view of a semiconductor nanorod used in an ink composition according to an embodiment.

### DETAILED DESCRIPTION

Hereinafter, embodiments of the present disclosure are described in more detail. However, these embodiments are just examples, the present disclosure is not limited thereto, and the present disclosure is defined by the scope of the appended claims, and equivalents thereof.

As used herein, when a specific definition is not otherwise provided, “alkyl group” refers to a C1 to C20 alkyl group, “alkenyl group” refers to a C2 to C20 alkenyl group, “cycloalkenyl group” refers to a C3 to C20 cycloalkenyl group, “heterocycloalkenyl group” refers to a C3 to C20 heterocycloalkenyl group, “aryl group” refers to a C6 to C20 aryl group, “arylalkyl group” refers to a C6 to C20 arylalkyl group, “alkylene group” refers to a C1 to C20 alkylene group, “arylene group” refers to a C6 to C20 arylene group, “alkylarylene group” refers to a C6 to C20 alkylarylene group, “heteroarylene group” refers to a C3 to C20 heteroarylene group, and “alkoxylene group” refers to a C1 to C20 alkoxylene group.

As used herein, when a specific definition is not otherwise provided, “substituted” may refer to substitution with a halogen atom (F, C1, Br, I), a hydroxy group, a C1 to C20 alkoxy group, a nitro group, a cyano group, an amine group, an imino group, an azido group, an amidino group, a hydrazino group, a hydrazono group, a carbonyl group, a carbamyl group, a thiol group, an ester group, an ether group, a carboxyl group or a salt thereof, a sulfonic acid group or a salt thereof, a phosphoric acid or a salt thereof, a C1 to C20 alkyl group, a C2 to C20 alkenyl group, a C2 to C20 alkynyl group, a C6 to C20 aryl group, a C3 to C20 cycloalkyl group, a C3 to C20 cycloalkenyl group, a C3 to C20 cycloalkynyl group, a C2 to C20 heterocycloalkyl group, a C2 to C20 heterocycloalkenyl group, a C2 to C20 heterocycloalkynyl group, a C3 to C20 heteroaryl group, or a combination thereof, instead of at least one hydrogen.

As used herein, when a specific definition is not otherwise provided, “hetero” may refer to one substituted with at least one hetero atom of N, O, S and P, in a chemical formula.

As used herein, when a specific definition is not otherwise provided, “(meth)acrylate” refers to both “acrylate” and “methacrylate,” and “(meth)acryl-based” refers to both “acryl-based” and “methacryl-based.”

As used herein, when a specific definition is not otherwise provided, the term “combination” refers to mixing or copolymerization.

As used herein, unless a specific definition is otherwise provided, a hydrogen atom is bonded at the position when a chemical bond is not drawn where supposed to be given. For example, the chemical structures shown herein may omit hydrogen atoms for clarity, and those of ordinary skill in the art would readily understand that hydrogen atoms are present at the expected positions in the corresponding chemical compounds even when not shown in the chemical structures.

In this specification, a semiconductor nanorod refers to a rod-shaped semiconductor having a nano-sized diameter.

As used herein, when a specific definition is not otherwise provided, “*” indicates a point where the same or different atom or chemical formula is linked.

An ink composition according to an embodiment includes (A) a semiconductor nanorod, and (B) a solvent including a compound represented by Chemical Formula 1 and having electrical conductivity of less than 2.0 μS/m at 25° C.

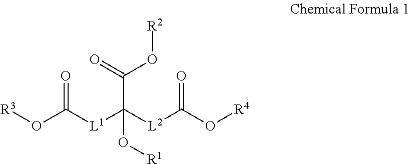

In Chemical Formula 1,
R¹ is a hydrogen atom or *—C(═O)R′ (wherein R′ is a hydrogen atom or a substituted or unsubstituted C1 to C10 alkyl group),
R² to R⁴ are each independently a substituted or unsubstituted C2 to C20 alkyl group, and
L¹ and L² are each independently a substituted or unsubstituted C1 to C20 alkylene group.

Recently, studies on various concepts having effects of improving energy efficiency and preventing or reducing a drop in efficiency of existing LEDs such as micro LEDs, mini LEDs, and the like have been actively conducted. Among them, an alignment (electrophoresis) of InGaN-based nanorod LEDs using an electric field has drawn attention as a method of dramatically reducing complex and expensive process costs of the micro LED, the mini LED, and the like.

However, organic solvents (propylene glycol methyl ether acetate (PGMEA), gamma butyrolactone (GBL), propylene glycol methyl ether (PGME), ethyl acetate, isopropyl alcohol (IPA), diethylene glycol monophenyl ether, and/or the like) generally used in a display and an electronic material have low viscosity and thus inorganic nanorod particles having high density may be sedimented or precipitated too fast and thus agglomerated, and in addition, may be quickly volatilized and thus may deteriorate or reduce alignment characteristics during the solvent drying after the dielectrophoresis. Accordingly, in order to develop an ink composition including inorganic nanorods (semiconductor nanorods), because a solvent having a high viscosity and a high boiling point and thus excellent dielectrophoretic characteristics to improve precipitation or sedimentation stability of the semiconductor nanorods is required or desired, the present inventors have significantly improved dielectrophoretic characteristics of the semiconductor nanorods in an ink composition and, for example, the degree of center alignment and the degree of biased alignment at the same time after repeating numerous trials and errors by including the compound represented by Chemical Formula 1 in a solvent used with the semiconductor nanorods and concurrently (e.g., simultaneously), controlling electrical conductivity to be less than 2.0 μS/m at 25° C.

Hereinafter, relevant components of embodiments of the ink composition are described in more detail.

### (A) Semiconductor Nanorod

The semiconductor nanorod may include a GaN-based compound, an InGaN-based compound, or a combination thereof, and may have a surface coated with a metal oxide.

For the dispersion stability of the semiconductor nanorod ink solution (semiconductor nanorod+solvent), a time of about 3 hours is usually required or desired, which is an extremely insufficient time to perform a large-area inkjet process. Accordingly, the present inventors, after numerous trials and errors of research, coated the surface of the semiconductor nanorod with a metal oxide including alumina, silica, or a combination thereof to form an insulating layer (Al₂O₃ and/or SiOₓ), thereby maximizing or increasing compatibility with the solvent further described herein below.

For example, the insulating layer formed by coating the surface of the semiconductor nanorod with the metal oxide may have a thickness of about 40 nm to about 60 nm.

The semiconductor nanorod may include an n-type confinement layer and a p-type confinement layer, and a multiquantum well active portion (MQW active region; multiquantum well active region) may be between the n-type confinement layer and the p-type confinement layer.

For example, the semiconductor nanorod may have a diameter of about 300 nm to about 900 nm, for example, about 600 nm to about 800 nm.

For example, the semiconductor nanorod may have a length of about 3.5 μm to about 5 μm.

For example, when the semiconductor nanorod includes an alumina insulating layer, the alumina insulating layer may have a density of about 5 g/cm³ to about 6 g/cm³.

For example, the semiconductor nanorod may have a mass of about 1×10⁻¹³ g to about 1×10⁻¹¹ g.

When the semiconductor nanorod has the above diameter, length, density, and type (or kind), surface coating of the metal oxide may be facilitated, and dispersion stability of the semiconductor nanorods may be maximized or increased.

The semiconductor nanorod may be included in the ink composition in an amount of about 0.01 wt % to about 10 wt %, for example, about 0.01 wt % to about 5 wt %, based on the total amount of the ink composition. In some embodiments, the semiconductor nanorods may be included in the ink composition in an amount of about parts by weight to about 0.5 parts by weight, for example, about 0.01 parts by weight to about 0.1 parts by weight, based on 100 parts by weight of the solvent in the ink composition. When the semiconductor nanorod is included within the above range, dispersibility of the semiconductor nanorod in the ink is good, and the manufactured pattern may have excellent luminance.

### (B) Solvent

The ink composition according to an embodiment includes a solvent having an electrical conductivity of less than about 2.0 μS/m at 25° C., for example, greater than or equal to about 0.1 μS/m and less than about 2.0 μS/m at 25° C., while including the compound represented by Chemical Formula 1.

Recently, as the needs for the nano-scale ultra-small LED devices are increasing, an attempt to manufacture a nano-scale GaN-based or InGaN-based compound semiconductor into a rod has been made, but there is a problem that dispersion stability of a semiconductor nanorod itself in a solvent (or a polymerizable compound) is greatly deteriorated or reduced. And until now, there has been no introduction of a technology capable of improving the dispersion stability of the semiconductor nanorods in a solvent (or polymerizable compound).

Organic solvents such as propylene glycol monomethyl ether acetate (PEGMEA), γ-butyrolactone (GBL), polyethylene glycol methyl ether (PGME), ethylacetate, isopropyl alcohol (IPA), diethylene glycol monophenyl ether (DGPE), and the like, which have been used in existing displays and electronic materials have such low viscosity that inorganic material nanorod particles having high density are too quickly sedimented or precipitated, resulting in unsuitable or unsatisfactory dielectrophoretic characteristics. Accordingly, as described above, in order to develop an ink composition for an electrophoretic device including inorganic nanorods (semiconductor nanorods), a solvent capable of imparting precipitation or sedimentation stability to the semiconductor nanorods is desirable to use.

In some embodiments, in order to improve storage stability as well as impart precipitation or sedimentation stability to the semiconductor nanorods, the solvent should have high viscosity at room temperature and also, a suitable or appropriate dielectric constant and electrical conductivity to secure excellent dielectrophoretic characteristics.

When the semiconductor nanorods are aligned in the ink composition by using an AC electric field, electrophoresis and dielectrophoresis concurrently (e.g., simultaneously) occur, so that particles (e.g., the semiconductor nanorods) may be aligned in a correct position (center alignment) in a correct direction (biased alignment) on a substrate. The electrophoresis and the dielectrophoresis are greatly affected by a dielectric constant and electrical conductivity of the semiconductor nanorods and the solvent. Because electrical characteristics of the semiconductor nanorods are almost similar, alignment characteristics of ink-jetted semiconductor nanorods may be determined by electrical characteristics of a solvent in which the semiconductor nanorods are dispersed.

However, an existing material, for example, diethylene glycol monophenyl ether (DGPE) exhibits a dielectric constant of about 9.4 and electrical conductivity of about 2.0 μS/m at about 25° C., wherein the alignment characteristics exhibit the degree of center alignment of about 85% and the degree of biased alignment of about 74%. Herein, as a result of applying triethyl citrate having a relatively low dielectric constant (dielectric constant of about 8.3 at about 25° C.) and high electrical conductivity (electrical conductivity of about 5.7 μS/m at about 25° C.), the center alignment is improved, but the degree of biased alignment is significantly deteriorated or reduced.

Accordingly, the present inventors have discovered that the degree of biased alignment is more affected by electrical conductivity of the solvent, wherein the lower the electrical conductivity, the greater the degree of biased alignment is improved, and in addition, the center alignment is kept at a similar level when the solvent has a dielectric constant within a set or specific range, thereby providing embodiments of the present disclosure based on this discovery after numerous experiments and repeated trials and errors. In other words, the present inventors have found that when a solvent having too high of a dielectric constant is used, the solvent other than the semiconductor nanorods may be attracted to the electrodes by a dielectrophoretic force, so that the semiconductor nanorods may not be well or suitably aligned, but when the solvent has too low a dielectric constant, an electric field of the ink composition becomes weakened or reduced, thereby weakening or reducing a force of attracting the semiconductor nanorods, and discovered that when an AC electric field is used to align the semiconductor nanorods, the semiconductor nanorods may be aligned to have an excellent alignment shape by concurrently (e.g., simultaneously) controlling a dielectric constant and electrical conductivity in the solvent in the ink composition, and in order to realize a solvent having the aforementioned characteristics, have improved the degree of the center alignment and the degree of the biased alignment concurrently (e.g., simultaneously) by controlling the solvent including the compound represented by Chemical Formula 1 to have electrical conductivity of less than about 2.0 μS/m at about 25° C.

For example, the solvent may have a dielectric constant (εᵣ) of about 5 to about 10, for example, a dielectric constant (εᵣ) of about 5 to about 9, for example, a dielectric constant (εᵣ) of about 5 to about 8, for example, a dielectric constant (εᵣ) of about 5 to about 7 at 25° C.

For example, the compound represented by Chemical Formula 1 may include a compound represented by Chemical Formula 1-1 or Chemical Formula 1-2, but is not necessarily limited thereto.

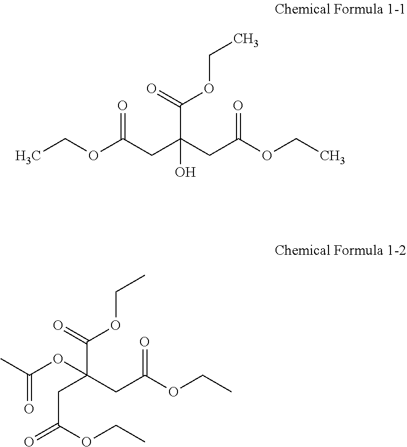

For example, the solvent may be a mixed solvent further including at least one compound having a different structure from that of the compound represented by Chemical Formula 1. In this case, it may be more desirable or suitable to concurrently (e.g., simultaneously) improve the degree of center alignment and the degree of biased alignment.

For example, the solvent further including at least one compound having a different structure from the compound represented by Chemical Formula 1 may have an electrical conductivity of less than or equal to about 0.3 μS/m at 25° C.

For example, the solvent may include the compound represented by Chemical Formula 1 and a compound represented by Chemical Formula 2.

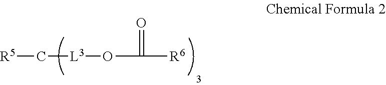

In Chemical Formula 2,
R⁵ and R⁶ are each independently a hydrogen atom or a substituted or unsubstituted C1 to C10 alkyl group, and
L³ is a substituted or unsubstituted C1 to C20 alkylene group.

For example, the solvent may include a compound represented by Chemical Formula 3, a compound represented by Chemical Formula 4, or a combination thereof together with the compound represented by Chemical Formula 1.

For example, the solvent may include a compound represented by Chemical Formula 1, a compound represented by Chemical Formula 3, and a compound represented by Chemical Formula 4.

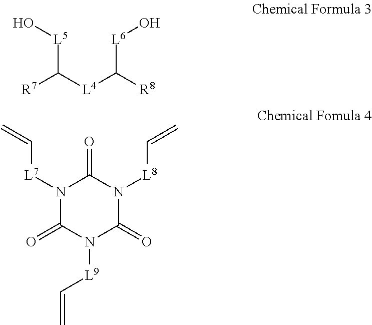

In Chemical Formula 3 and Chemical Formula 4,
R⁷ and R⁸ are each independently a hydrogen atom or a substituted or unsubstituted C1 to C10 alkyl group, and
L⁴ to L⁹ are each independently a substituted or unsubstituted C1 to C20 alkylene group.

For example, the solvent may include a compound represented by Chemical Formula 5, a compound represented by Chemical Formula 6, a compound represented by Chemical Formula 7, or a combination thereof together with the compound represented by Chemical Formula 1.

For example, the solvent may include a compound represented by Chemical Formula 1, a compound represented by Chemical Formula 5, a compound represented by Chemical Formula 6, and a compound represented by Chemical Formula 7.

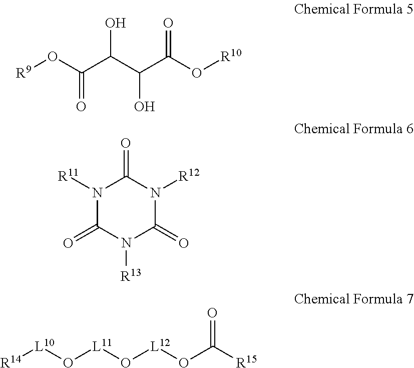

In Chemical Formula 5 to Chemical Formula 7,
R⁹ to R¹⁵ are each independently a hydrogen atom or a substituted or unsubstituted C1 to C10 alkyl group, and
L¹⁰ to L¹² are each independently a substituted or unsubstituted C1 to C20 alkylene group.

For example, the solvent may further include a compound represented by Chemical Formula 8.

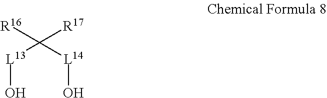

In Chemical Formula 8,
R¹⁶ and R¹⁷ are each independently a hydrogen atom or a substituted or unsubstituted C1 to C10 alkyl group, and
L¹³ and L¹⁴ are each independently a substituted or unsubstituted C1 to C20 alkylene group.

For example, in Chemical Formula 8, R¹⁶ and R¹⁷ may each independently be a substituted or unsubstituted C1 to C10 alkyl group, and R¹⁶ and R¹⁷ may be different from each other.

For example, the solvent may include the compound represented by Chemical Formula 1 and the compound represented by Chemical Formula 8.

For example, the solvent may include the compound represented by Chemical Formula 1, the compound represented by Chemical Formula 2, and the compound represented by Chemical Formula 8.

For example, the solvent may include the compound represented by Chemical Formula 1, the compound represented by Chemical Formula 3, the compound represented by Chemical Formula 4, and the compound represented by Chemical Formula 8.

For example, the solvent may include the compound represented by Chemical Formula 1, the compound represented by Chemical Formula 5, the compound represented by Chemical Formula 6, the compound represented by Chemical Formula 7, and the compound represented by Chemical Formula 8.

The solvent may be included in the ink composition in an amount of about 15 wt % to about 99.99 wt %, for example about 20 wt % to about 99.7 wt %, based on the total amount of the ink composition.

### Polymerizable Monomer

The ink composition according to an embodiment may further include a polymerizable compound. The polymerizable compound may be used by mixing together monomers or oligomers generally used in existing curable compositions.

For example, the polymerizable compound may be a polymerizable monomer having a carbon-carbon double bond at its terminal end.

For example, the polymerizable compound may be a polymerizable monomer having at least one selected from a functional group represented by Chemical Formula A-1 and a functional group represented by Chemical Formula A-2 at its terminal end.

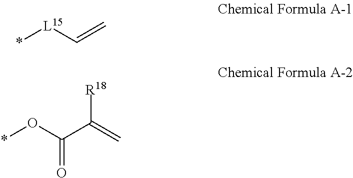

In Chemical Formula A-1 and Chemical Formula A-2,
L¹⁵ is a substituted or unsubstituted C1 to C20 alkylene group, and
R¹⁸ is a hydrogen atom or a substituted or unsubstituted C1 to C20 alkyl group.

The polymerizable compound includes at least one carbon-carbon double bond at a terminal end thereof, for example, a functional group represented by Chemical Formula A-1 and/or a functional group represented by Chemical Formula A-2, which allows it to form a crosslinked structure together with the surface-modifying compound. The crosslinked body thus formed may further enhance dispersion stability of the semiconductor nanorods by further doubling a type (or kind) of steric hindrance effect.

For example, the polymerizable compound including at least one functional group represented by Chemical Formula A-1 at a terminal end thereof may be divinyl benzene, triallyl cyanurate, triallyl isocyanurate, triallyl trimellitate, triallyl phosphate, triallyl phosphite, triallyl triazine, diallyl phthalate, or a combination thereof, but is not necessarily limited thereto.

For example, the polymerizable compound including at least one functional group represented by Chemical Formula A-2 at a terminal end thereof may be ethylene glycol diacrylate, triethylene glycol diacrylate, 1,4-butanediol diacrylate, 1,6-hexane diol diacrylate, neopentyl glycol diacrylate, pentaerythritol diacrylate, pentaerythritol triacrylate, dipentaerythritol diacrylate, dipentaerythritol triacrylate, dipentaerythritol pentaacrylate, pentaerythritol hexaacrylate, bisphenol A diacrylate, trimethylolpropane triacrylate, novolac epoxy acrylate, ethylene glycol dimethacrylate, diethylene glycol dimethacrylate, triethylene glycol dimethacrylate, propylene glycol dimethacrylate, 1,4-butanediol dimethacrylate, 1,6-hexanediol dimethacrylate, polyfunctional epoxy (meth)acrylate, polyfunctional urethane (meth)acrylate, KAYARAD DPCA-20, KAYARAD DPCA-30, KAYARAD DPCA-60, KAYARAD DPCA-120, or KAYARAD DPEA-12 of Nippon Chemical Co., Ltd., or a combination thereof, but is not necessarily limited thereto.

The polymerizable compound may be used after being treated with an acid anhydride to impart better developability.

### Polymerization Initiator

The ink composition according to an embodiment may further include a polymerization initiator, for example, a photopolymerization initiator, a thermal polymerization initiator, or a combination thereof.

The photopolymerization initiator may be any suitable generally-used initiator for a curable composition and may be, for example, an acetophenone-based compound, a benzophenone-based compound, a thioxanthone-based compound, a benzoin-based compound, a triazine-based compound, an oxime-based compound, an aminoketone-based compound, and/or the like, but is not necessarily limited thereto.

Examples of the acetophenone-based compound may be 2,2′-diethoxy acetophenone, 2,2′-dibutoxy acetophenone, 2-hydroxy-2-methylpropinophenone, p-t-butyltrichloro acetophenone, p-t-butyldichloro acetophenone, 4-chloro acetophenone, 2,2′-dichloro-4-phenoxy acetophenone, 2-methyl-1-(4-(methylthio)phenyl)-2-morpholinopropan-1-one, 2-benzyl-2-dimethylamino-1-(4-morpholinophenyl)-butan-1-one, and the like.

Examples of the benzophenone-based compound may be benzophenone, benzoyl benzoate, benzoyl methyl benzoate, 4-phenyl benzophenone, hydroxybenzophenone, acrylated benzophenone, 4,4′-bis(dimethyl amino)benzophenone, 4,4′-bis(diethylamino)benzophenone, 4,4′-dimethylaminobenzophenone, 4,4′-dichlorobenzophenone, 3,3′-dimethyl-2-methoxybenzophenone, and the like.

Examples of the thioxanthone-based compound may be thioxanthone, 2-methylthioxanthone, isopropyl thioxanthone, 2,4-diethyl thioxanthone, 2,4-diisopropyl thioxanthone, 2-chlorothioxanthone, and the like.

Examples of the benzoin-based compound may be benzoin, benzoin methyl ether, benzoin ethyl ether, benzoin isopropyl ether, benzoin isobutyl ether, benzyldimethylketal, and the like.

Examples of the triazine-based compound may be 2,4,6-trichloro-s-triazine, 2-phenyl-4,6-bis(trichloromethyl)-s-triazine, 2-(3′,4′-dimethoxystyryl)-4,6-bis(trichloromethyl)-s-triazine, 2-(4′-methoxynaphthyl)-4,6-bis(trichloromethyl)-s-triazine, 2-(p-methoxyphenyl)-4,6-bis(trichloromethyl)-s-triazine, 2-(p-tolyl)-4,6-bis(trichloro methyl)-s-triazine, 2-biphenyl-4,6-bis(trichloro methyl)-s-triazine, bis(trichloromethyl)-6-styryl-s-triazine, 2-(naphthol-yl)-4,6-bis(trichloromethyl)-s-triazine, 2-(4-methoxynaphtho1-yl)-4,6-bis(trichloromethyl)-s-triazine, 2-4-bis(trichloromethyl)-6-piperonyl-s-triazine, 2-4-bis(trichloromethyl)-6-(4-methoxystyryl)-s-triazine, and the like.

Examples of the oxime-based compound may be an O-acyloxime-based compound, 2-(0-benzoyloxime)-1-[4-(phenylthio)phenyl]-1,2-octanedione, 1-(0-acetyloxime)-1-[9-ethyl-6-(2-methylbenzoyl)-9H-carbazol-3-yl]ethanone, 0-ethoxycarbonyl-α-oxyamino-1-phenylpropan-1-one, and the like. Examples of the O-acyloxime-based compound may be 1,2-octandione, 2-dimethylamino-2-(4-methylbenzyl)-1-(4-morpholin-4-yl-phenyl)-butan-1-one, 1-(4-phenylsulfanyl phenyl)-butane-1,2-dione-2-oxime-O-benzoate, 1-(4-phenylsulfanyl phenyl)-octane-1,2-dione-2-oxime-O-benzoate, 1-(4-phenylsulfanyl phenyl)-octan-1-oneoxime-O-acetate, 1-(4-phenylsulfanyl phenyl)-butan-1-oneoxime-O-acetate, and the like.

Examples of the aminoketone-based compound may be 2-benzyl-2-dimethylamino-1-(4-morpholinophenyl)-butanone-1, and the like.

The photopolymerization initiator may further include a carbazole-based compound, a diketone-based compound, a sulfonium borate-based compound, a diazo-based compound, an imidazole-based compound, a biimidazole-based compound, and the like, besides the other compounds described herein.

The photopolymerization initiator may be used together with a photosensitizer capable of causing or promoting a chemical reaction by absorbing light and becoming excited and then transferring its energy.

Examples of the photosensitizer may be tetraethylene glycol bis-3-mercapto propionate, pentaerythritol tetrakis-3-mercapto propionate, dipentaerythritol tetrakis-3-mercapto propionate, and the like.

Examples of the thermal polymerization initiator may include peroxide, for example, benzoyl peroxide, dibenzoyl peroxide, lauryl peroxide, dilauryl peroxide, di-tert-butyl peroxide, cyclohexane peroxide, methyl ethyl ketone peroxide, oxides, hydroperoxide (e.g., tert-butyl hydroperoxide, cumene hydroperoxide, etc.), dicyclohexyl peroxydicarbonate, 2,2-azo-bis(isobutyronitrile), t-butyl perbenzoate, 2,2′-azobis-2-methylpropionitrile, etc., but are not necessarily limited thereto, and any suitable one generally used in the art may be used.

The polymerization initiator may be included in the ink composition in an amount of about 1 wt % to about 5 wt %, for example, about 2 wt % to about 4 wt %, based on the total amount of solid components constituting the ink composition. When the polymerization initiator is included within the above range, excellent reliability may be obtained due to suitable or sufficient curing during exposure and/or thermal curing.

### Other Additives

The ink composition according to an embodiment may further include a polymerization inhibitor including a hydroquinone-based compound, a catechol-based compound, or a combination thereof. As the ink composition according to an embodiment further includes the hydroquinone-based compound, the catechol-based compound, or a combination thereof, crosslinking at room temperature may be prevented or reduced during exposure after printing (e.g., coating) the ink composition.

For example, the hydroquinone-based compound, the catechol-based compound, or the combination thereof may be hydroquinone, methyl hydroquinone, methoxyhydroquinone, t-butyl hydroquinone, 2,5-di-t-butyl hydroquinone, 2,5-bis(1,1-dimethylbutyl) hydroquinone, 2,5-bis (1,1,3,3-tetramethylbutyl) hydroquinone, catechol, t-butyl catechol, 4-methoxyphenol, pyrogallol, 2,6-di-t-butyl-4-methylphenol, 2-naphthol, tris(N-hydroxy-N-nitrosophenylaminato-O,O′)aluminum, or a combination thereof, but are not necessarily limited thereto.

The hydroquinone-based compound, catechol-based compound, or combination thereof may be used in a form of a dispersion, and the polymerization inhibitor in a form of the dispersion may be included in the ink composition in an amount of about 0.001 wt % to about 1 wt %, for example about 0.01 wt % to about 0.1 wt % based on the total amount of the ink composition. When the polymerization inhibitor is included within the ranges, passage of time (e.g., dispersion stability) at room temperature may be solved or improved and concurrently (e.g., simultaneously), sensitivity deterioration or reduction and surface delamination phenomenon may be inhibited or reduced.

The ink composition according to an embodiment may include: malonic acid; 3-amino-1,2-propanediol; a silane-based coupling agent; a leveling agent; a fluorine-based surfactant; or a combination thereof, in addition to the polymerization inhibitor.

For example, the ink composition may further include a silane-based coupling agent having a reactive substituent such as a vinyl group, a carboxyl group, a methacryloxy group, an isocyanate group, an epoxy group and/or the like in order to improve close contacting properties with a substrate.

Examples of the silane-based coupling agent may be trimethoxysilyl benzoic acid, γ-methacryl oxypropyl trimethoxysilane, vinyl triacetoxysilane, vinyl trimethoxysilane, γ-isocyanate propyl triethoxysilane, γ-glycidoxy propyl trimethoxysilane, β-epoxycyclohexyl)ethyltrimethoxysilane, and the like, and these may be used alone or in a mixture of two or more.

The silane-based coupling agent may be used in the ink composition in an amount of about 0.01 parts by weight to about 10 parts by weight based on 100 parts by weight of the ink composition. When the silane-based coupling agent is included within the above range, close contacting properties, storage capability, and the like are improved.

In addition, the ink composition may further include a surfactant, such as a fluorine-based surfactant, to improve coating properties and prevent or reduce defect formation, if necessary or desired.

Examples of the fluorine-based surfactant may be BM-1000®, BM-1100®, and the like of BM Chemie Inc.; MEGAFACE F 142D®, MEGAFACE F 172®, MEGAFACE F 173®, MEGAFACE F 183®, and the like of Dainippon Ink Kagaku Kogyo Co., Ltd.; FLUORAD FC-135®, FLUORAD FC-170C®, FLUORAD FC-430®, FLUORAD FC-431®, and the like of Sumitomo 3M Co., Ltd.; SURFLON S-112®, SURFLON S-113®, SURFLON S-131®, SURFLON S-141®, SURFLON S-145®, and the like of ASAHI Glass Co., Ltd.; SH-28PA®, SH-190®, SH-193®, SZ-6032®, SF-8428®, and the like of Toray Silicone Co., Ltd.; F-482, F-484, F-478, F-554, and the like of DIC Co., Ltd.

The fluorine-based surfactant may be included in the ink composition in an amount of about 0.001 parts by weight to about 5 parts by weight based on 100 parts by weight of the ink composition. When the fluorine-based surfactant is included within the above range, coating uniformity is secured or improved, stains do not occur, and wettability to a glass substrate is excellent.

In addition, the ink composition may further include other additives such as an antioxidant, a stabilizer, and/or the like in a set or predetermined amount, unless properties are undesirably deteriorated or reduced.

Another embodiment provides a layer using an ink composition.

Another embodiment provides a display device including the layer. For example, the display device may be an electrophoresis apparatus.

Hereinafter, embodiments of the present disclosure are illustrated in more detail with reference to examples. These examples, however, are not in any sense to be interpreted as limiting the scope of the disclosure.

### Preparation of Ink Composition

### Examples 1 to 4 and Comparative Examples 1 and 2

40 ml of stearic acid (1.5 mM) is reacted on a nanorod-patterned InGaN wafer (4 inches) at room temperature for 24 hours. After the reaction, the wafer is dipped in 50 ml of acetone for 5 minutes to remove excess stearic acid, and the surface of the wafer is additionally rinsed with 40 ml of acetone. The cleaned wafer is put together with 35 ml of GBL in a 27 kW bath-type sonicator and then sonicated for 5 minutes to separate the nanorod from the wafer surface. The separated nanorod is put in a FALCON tube for centrifugation, and 10 ml of GBL is added thereto to additionally wash the nanorod on the bath surface. After discarding a supernatant through the centrifugation at 4000 rpm for 10 minutes, precipitates obtained therefrom are redispersed in 40 ml of acetone and then passed through a 10 μm mesh filter to filter out foreign matters. After additional centrifugation (4000 rpm, 10 minutes), the precipitates are dried in a drying oven (100° C., 1 hour) and then weighed and dispersed to be 0.05 w/w %, thereby preparing an ink composition having a composition shown in Table 1.

A respective composition of a mixed solvent, and a dielectric constant and electrical conductivity of the solvent at 25° C. of Examples 1 to 4 and Comparative Examples 1 and 2 are shown in Table 2.

TABLE 1
(unit: wt %)

| | | | Amount |
|---|---|---|---|
| (A) InGaN nanorod | | | 0.05 |
| (B) Solvent | | | 99.8 |
| (C) | (C-1) | Fluorine-based surfactant (F-554, DIC Co., | 0.07 |
| Other | | Ltd.) | |
| additives | (C-2) | Polymerization inhibitor | 0.08 |
| | | (methyl hydroquinone, TOKYO | |
| | | CHEMICAL Co.) | |

TABLE 2

| Mixed | | | | | Comp. Ex. | Comp. |
|---|---|---|---|---|---|---|
| solvent | Ex. 1 | Ex. 2 | Ex. 3 | Ex. 4 | 1 | Ex. 2 |
| Dielectric | 5.4 | 6.7 | 6.4 | 6.1 | 9.4 | 8.3 |
| constant (εᵣ) | | | | | | |
| (@25º C.) | | | | | | |
| Electrical | 0.1 | 0.1 | 0.15 | 0.2 | 2.0 | 5.7 |
| conductivity | | | | | | |
| (μS/m) | | | | | | |
| (@25º C.) | | | | | | |
| Solvent | Chemical | Chemical | Chemical | Chemical | Diethylene | Chemical |
| composition | Formula | Formula | Formula | Formula | Glycol | Formula |
| (wt %) | 1-2 | 1-1 | 1-1 | 1-2 | Monophenyl | 1-1 |
| | (50) | (35) | (30) | (60) | Ether | (99.8) |
| | | | | | (99.8) | |
| | Chemical | Chemical | Chemical | Chemical | | |
| | Formula | Formula | Formula | Formula | | |
| | 2-1 | 3-1 | 5-1 | 2-1 | | |
| | (49.8) | (20) | (20) | (35) | | |
| | | Chemical | Chemical | Chemical | | |
| | | Formula | Formula | Formula | | |
| | | 4-1 (44.8) | 6-1 (30) | 8-1 (4.8) | | |
| | | | Chemical | | | |
| | | | Formula | | | |
| | | | 7-1 (19.8) | | | |

### Evaluation: Electrophoretic Characteristics

500 μl of a respective ink composition according to Examples 1 to 4 and Comparative Examples 1 and 2 is coated on a thin-film gold basic interdigitated linear electrode (ED-cIDE4-Au, MicruX Technologies) and after applying an electric field (25 KHz, ±30 v) thereto, left for 1 minute. After drying the solvent by using a hot plate, each composition is evaluated with respect to electrophoretic characteristics by examining the number (ea) of the aligned rods and the number (ea) of the non-aligned rods in the center between the electrodes by using a microscope, and the results are shown in Table 3.

TABLE 3

| | Ex. 1 | Ex. 2 | Ex. 3 | Ex. 4 | Comp. Ex. 1 | Comp. Ex. 2 |
|---|---|---|---|---|---|---|
| Degree of center | 91 | 92 | 94 | 89 | 85 | 93 |
| alignment (%) | | | | | | |
| Degree of biased | 90 | 96 | 94 | 98 | 74 | 51 |
| alignment (%) | | | | | | |

As shown in Table 3, Examples 1 to 4 exhibit significantly improved degree of center alignment and the degree of biased alignment at the same time, compared with Comparative Examples 1 and 2 (the degree of center alignment and the degree of biased alignment of Examples 1 to 4 are respectively improved to be 89% or higher), which turn out to be suitable for large area coating and panel production.

While the subject matter of this disclosure has been described in connection with what is presently considered to be practical example embodiments, it is to be understood that the present disclosure is not limited to the disclosed embodiments, but, on the contrary, is intended to cover various modifications and equivalent arrangements included within the spirit and scope of the appended claims, and equivalents thereof.

What is claimed is:

1. An ink composition, comprising:
(A) a semiconductor nanorod; and
(B) a solvent comprising a compound represented by Chemical Formula 1,
wherein the solvent has an electrical conductivity of less than 2.0 μS/m at 25° C.: 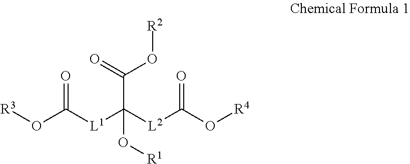
wherein, in Chemical Formula 1,
R¹ is a hydrogen atom or *—C(═O)R′, wherein R′ is a hydrogen atom or a substituted or unsubstituted C1 to C10 alkyl group,
R² to R⁴ are each independently a substituted or unsubstituted C2 to C20 alkyl group, and
L¹ and L² are each independently a substituted or unsubstituted C1 to C20 alkylene group.

2. The ink composition of claim 1, wherein:
the solvent has a dielectric constant (εᵣ) of about 5 to about 10 at 25° C.

3. The ink composition of claim 1, wherein:
the compound represented by Chemical Formula 1 comprises a compound represented by Chemical Formula 1-1 or Chemical Formula 1-2:

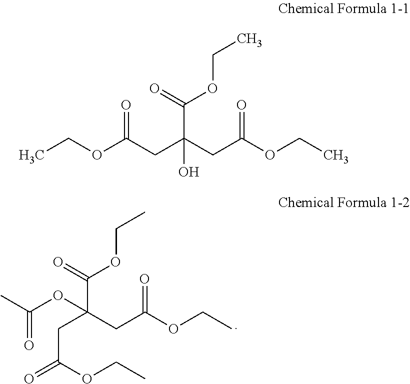

4. The ink composition of claim 1, wherein:
the solvent further comprises at least one compound having a different structure from that of the compound represented by Chemical Formula 1.

5. The ink composition of claim 4, wherein:
the solvent further comprising at least one compound having a different structure from the compound represented by Chemical Formula 1 has an electrical conductivity of less than or equal to about 0.3 μS/m at 25° C.

6. The ink composition of claim 4, wherein:
the solvent further comprises a compound represented by Chemical Formula 2: 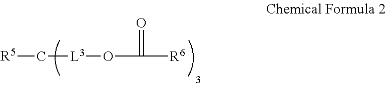
wherein, in Chemical Formula 2,
R⁵ and R⁶ are each independently a hydrogen atom or a substituted or unsubstituted C1 to C10 alkyl group, and
L³ is a substituted or unsubstituted C1 to C20 alkylene group.

7. The ink composition of claim 4, wherein:
the solvent further comprises a compound represented by Chemical Formula 3, a compound represented by Chemical Formula 4, or a combination thereof: 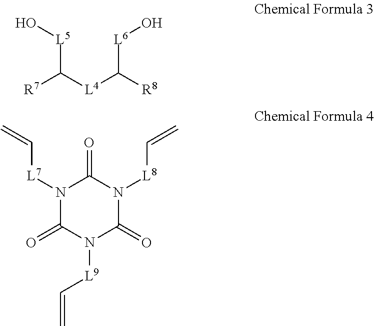
wherein, in Chemical Formula 3 and Chemical Formula 4,
R⁷ and R⁸ are each independently a hydrogen atom or a substituted or unsubstituted C1 to C10 alkyl group, and
L⁴ to L⁹ are each independently a substituted or unsubstituted C1 to C20 alkylene group.

8. The ink composition of claim 4, wherein:
the solvent further comprises a compound represented by Chemical Formula 5, a compound represented by Chemical Formula 6, a compound represented by Chemical Formula 7, or a combination thereof: 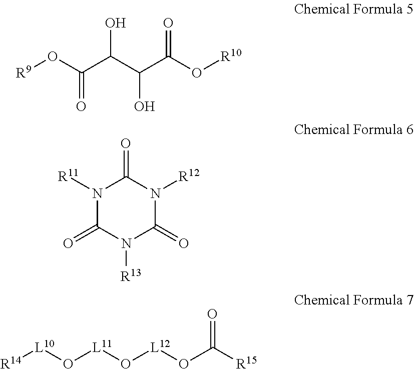
wherein, in Chemical Formula 5 to Chemical Formula 7,
R⁹ to R¹⁵ are each independently a hydrogen atom or a substituted or unsubstituted C1 to C10 alkyl group, and
L¹⁰ to L¹² are each independently a substituted or unsubstituted C1 to C20 alkylene group.

9. The ink composition of claim 4, wherein:
the solvent further comprises a compound represented by Chemical Formula 8: 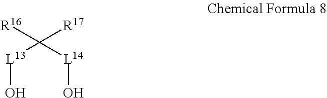
wherein, in Chemical Formula 8,
R¹⁶ and R¹⁷ are each independently a hydrogen atom or a substituted or unsubstituted C1 to C10 alkyl group, and
L¹³ and L¹⁴ are each independently a substituted or unsubstituted C1 to C20 alkylene group.

10. The ink composition of claim 9, wherein:
R¹⁶ and R¹⁷ are each independently a substituted or unsubstituted C1 to C10 alkyl group and R¹⁶ and R¹⁷ are different from each other.

11. The ink composition of claim 1, wherein:
the semiconductor nanorod has a diameter of about 300 nm to about 900 nm.

12. The ink composition of claim 1, wherein:
the semiconductor nanorod has a length of about 3.5 μm to about 5 μm.

13. The ink composition of claim 1, wherein:
the semiconductor nanorod comprises a GaN-based compound, an InGaN-based compound, or a combination thereof.

14. The ink composition of claim 1, wherein:
the semiconductor nanorod has a surface coated with a metal oxide.

15. The ink composition of claim 14, wherein:
the metal oxide comprises alumina, silica, or a combination thereof.

16. The ink composition of claim 1, wherein:
the semiconductor nanorod is included in an amount of about 0.01 wt % to about wt % based on the total amount of the ink composition.

17. The ink composition of claim 1, wherein:
the ink composition further comprises: malonic acid; 3-amino-1,2-propanediol; a silane-based coupling agent; a leveling agent; a fluorine-based surfactant; or a combination thereof.

18. A layer manufactured using the ink composition of claim 1.

19. An electrophoresis apparatus comprising the layer of claim 18.

20. A display device comprising the layer of claim 18.
